(19) United States
(12) Patent Application Publication
(10) Pub. No.: US 2009/0282249 A1
(43) Pub. Date: Nov. 12, 2009

(54) PROCESS FOR ESTABLISHING A SECRET KEY

(75) Inventors: Frederik Aamknecht, Worms (DE); Dirk Westhoff, Neustadt an der Weinstrasse (DE)

Correspondence Address: YOUNG & THOMPSON, 209 Madison Street, Suite 500, ALEXANDRIA, VA, 22314, US

(73) Assignee: NEC EUROPE LTD., Heidelberg (DE)

(21) Appl. No.: 12/304,605

(22) PCT Filed: Jun. 5, 2007
(86) PCT No.: PCT/EP07/04974

§ 371 Date: Feb. 4, 2009

(30) Foreign Application Priority Data
Jun. 13, 2006 (DE) 10 2006 027 639.6

(51) Int. Cl. H04L 9/08; H04L 9/28

(52) U.S. Cl. 713/171; 380/28

(57) ABSTRACT

A method for establishing a secret key for a data transmission between communication partners in a network, in particular in a personal area network (PAN), or in a body area network (BAN), wherein one or several inefficient communication partners (B) in comparison to a strong, preferably central communication partner (A) of the network, have reduced power resources, is characterized through the following steps: the strong communication partner (A) transmits a plurality of data pairs, each comprising a possible key (Kⱼ) and an identification (IDᵢ), to the weak communication partner (B) in a concealed manner, the weak communication partner (B) randomly selects a data pair from the plurality of data pairs, reveals the concealment of the data pair and sends the respective identification (IDⱼ) back to the strong communication partner (A), the strong communication partner (A) reconstructs the associated key (Kⱼ) from the received identification (IDⱼ), said key (Kⱼ) then being used as a secret key for the data transmission between the strong and the weak communication partner.

The invention relates to a process for establishing a secret key for data transmission between communication partners in a network, in particular in a personal area network (PAN), or in a body area network (BAN), wherein one or several inefficient communication partners have reduced power resources, compared to a strong, preferably central communication partner of the network.

Methods of this kind have been known in practical applications for quite a while and are being used in particular in asymmetrical wireless networks, in which the resources of the network components communicating with each other are distributed in a quite uneven manner, Such unevenly distributed power resources occur e.g. in wireless personal area networks (PAN), which are generally being used for ad hoc networking of small devices. Practically speaking this means e.g. networking PDAs, printers, notebooks, and/or mobile telephones. In such networks typically distances in the range of a few meters can be bridged. Within the network generally point to point, possibly also point to multipoint, connections are being realized.

In a body area network (BAN) conditions are very similar, In this kind of network, communication partners, generally provided as miniaturized transmitters, which are carried on the body, communicate wirelessly with a central component, which can possibly also be carried on the body, and can function as an interface for an external access.

However, it is characteristic for such types of networks, that the networks comprise communication partners which are provided quite differently with respect to their power, energy resources, storage capacity, processing capacity, etc. The inefficient (or weak) communication partners, this means those components of the network which have extremely low power, have proven to be problematic with respect to the security of the data transfer within the network. Often the conditions are so that the computing power and/or the storage capacity of the weaker communication partners are not sized sufficiently, in order to perform the calculations necessary for a sufficient level of security during data transmission. These problems become e.g. very apparent when the BANs, which have been mentioned initially, are being considered, in which to some extent very sensitive biometric patient data from extremely miniaturized biosensors have to be securely transmitted to a base station of any kind.

In the past known methods were used for the key exchange between the communication partners, as e.g. Diffie-Hellmann-Methods, in particular Diffie-Hellmann-Methods on elliptic curves, or RSA methods, wherein it was attempted to adapt the methods, so that as little computing effort as possible is necessary for the weaker communication partner. Thus it has e.g. been attempted to perform the RSA method with a low public exponent. Through this method, the computation effort necessary in the weak communication partner can be reduced. In the light of the circumstance, that the base value of the exponent has to be a value with a size in the range of 1,000 bit in practical applications, the effort is often still too high for the weak communication partner, in spite of the said adaptation. The storage capacity, computing power, and energy necessary for the key exchange and for efficient encryption, cannot be lowered below a certain, often too high threshold on the side of the weak partner.

Recently research has been published (C. Castellucia, G. Avoine, “Noisy Tags: A pretty good key exchange protocol for RFID tags”, in Lecture Notes in Computer Science, Vol. 3928/2006, Springer Berlin/Heidelberg), which relates to key exchange protocols for the communication between RFID tags (Radio Frequency IDentification) as weak communication partners and a reader as strong communication partner. Therein, on the one hand possibilities for exchanging a secret key are described, which are tied to certain physical conditions, as e.g. a physical contact between the communication partners. Alternatively it is possible to perform the exchange in a physically protected environment, e.g. within a Faraday cage. Depending on the application, these physical conditions often cannot be realized in practical applications. In order to circumvent these problems, the said research suggests a method in which special devices are being used within the network, which send a random sound sequence via the public channel. The security of the key exchange between two communication partners in this method is based on an eavesdropper not being able to filter the key out from the noise transmitted via the same channel.

It is the object of the present invention to provide a process for establishing a secret key of the type described above, through which a high level of security is accomplished, without requiring additional specific devices, and with an effort that is as low as possible for the weaker communication partner.

According to the invention the above object is accomplished through a method with the features of patent claim 1. The method accordingly comprises the following steps:
the strong communication partner transmits a plurality of data pairs in a concealed manner, each comprising a possible key and an identification, to the weak communication partner,
the weak communication partner randomly selects a data pair from the plurality of data pairs, reveals the concealment of the data pair and sends the respective identification back to the strong communication partner,
the strong communication partner reconstructs the associated key from the received identification, said key then being used as secret key for the data transmission between the strong and the weak communication partner.

According to the invention it has at first been recognized that the data transmission within a network, in which extremely weak, i.e. inefficient, components are involved, causes particular problems with respect to security issues, which cannot be solved satisfactory with classic key exchange protocols. For solving these particular problems, the invention suggests using a protocol, which is a combination of cryptography (encryption of data) and steganography (making data invisible). Since the weak communication partner only has to reveal a concealment in the course of the method according to the invention, and perform a transmit/receive process, the method is suitable in particular for asymmetric architectures. Through suitable adaptation of the parameters it is possible to keep the processing effort required in the course of the key exchange low for the weaker communication partner, without reducing security.

The transmission of the data pairs from A—strong communication partner—to B—weak communication partner—, and the transmission of an identification from B to A can be performed via a public channel, since the transmitted data by themselves are worthless for an attacker, this means unless the attacker makes additional considerable efforts. Insofar the process according to the invention is particularly suited for application in scenarios, in which a certain security level has to be reached for a limited time period only. Under the assumption that the relative power ratio between an attacker and the weak communication partner is known, the process according to the invention delivers an exactly determinable security level.

Moreover, the method according to the invention is extremely robust against instabilities on the wireless channel, since data losses are inoffensive in terms of the functionality of the protocol, and furthermore do not affect the security level. Eventually a particular advantage of the process according to the invention is based on the fact that preliminary to the key exchange no determination of any common knowledge/secrets is required, and that in particular no additional components are required for the key exchange.

Through an advantageous embodiment the concealment of the data pairs is accomplished by the strong communication partner performing an encryption of the data pairs and transmitting the data pairs to the weak communication partner in an encrypted manner. In a particular advantageous manner, the encryption is an encryption that is easy to decrypt. Hereby, the computation effort can be further reduced, thus, on the side of the strong communication partner with respect to the encryption, and also on the side of the weak communication partner with respect to the decryption. The fact that an eavesdropper can easily break the light encryption during the transmission of the data pairs via a public channel is irrelevant insofar, as he, in spite of a decryption, does not gain information, since he does not know which key the weak communication partner will select from the plurality of the transmitted keys. In case the selected encryption should still prove too weak, e.g. in consideration of an extremely powerful attacker, it can easily be replaced through a stronger encryption.

With respect to a flexible application of the method, it can be provided that the length of the keys with which the strong communication partner encrypts the data pairs, is determined corresponding to the respective security requirement and/or the respective power of the weak communication partner. Thus e.g. short keys could be determined for the case that the weak communication partners are RFIDs, this means extremely low end devices, and that at the same time a time limited security is sufficient. In a practical application, e.g. a RC5 encryption could be selected, wherein in a plurality of possible applications, an RC5 encryption with a key length between 16 and 64 bits could prove to be suitable.

For assuring a correct decryption of the data pairs through the weak communication partner, it can be provided that the data pairs are each expanded by a characteristic bit string. This bit string (“padding”) is provided so that it enables the weak communication partner to differentiate the correct plain text from false plain texts. For this, however, either larger plain text blocks would have to be used, which increases the transmitting effort for the strong communication partner, or the key size would have to be reduced, which would lead to a reduction of the security level.

In order to circumvent these disadvantages, the plain text of the data pairs (IDᵢ∥Kᵢ) respectively is linked with the key kᵢ used for encrypting the data pair. The linking can thereby e.g. be performed so that the key kᵢ used for encrypting the data pairs is generated from a predeterminable number of bits of the key kᵢ. In other words, the strong communication partner can use n bits of the key Kᵢ, instead of a random value, in order to form the key kᵢ. In a practical application, this can be e.g. respectively the last n bits of Kᵢε{0, 1}^{N}. In case Kᵢ=(K₀, . . . , K_{N-1}) the strong communication partner defines accordingly kᵢ:=(K_{N-n}, . . . , K_{N-1}) and computes—by applying a block encryption εₖ−Cᵢ:=εₖᵢ(IDᵢ, ∥Kᵢ)=ε_{(KN-n, . . . , KN-1)}(IDᵢ, ∥Kᵢ). The differentiation between a wrong and the correct plain text then comprises testing if the last n bits of εₖᵢ⁻¹(Cᵢ) are equal to kᵢ. Under the assumption that this condition generally applies with a probability of 2⁻ⁿ, it can be assumed, that this test enables a unique identification of the correct plain text.

With respect to a further increase in flexibility, it can be provided that the number of the data pairs to be sent by the strong communication partner is determined according to the respective security requirements. The more data pairs are being sent, the more potential keys exist, and the effort that an eavesdropper has to make in order to determine the key that was actually selected is increased significantly.

In a further advantageous manner, the strong communication partner sends a message before sending the first data pair, through which the beginning of the transmission process of the data pairs is indicated to the weak communication partner. Additionally, the message can comprise information with respect to the expected duration of the transmission process. For the weak communication partner, this procedure has the very significant advantage that he does not have to be ready to receive all the time, and does not have to receive all transmitted data pairs. In the extreme, it can even be sufficient for the weak communication partner to be ready to receive only for a short time during the duration of the transmission process and thereby only receive a single data pair out of the plurality of data pairs transmitted. In this way, the limited resources of the weak communication partner are only used minimally. In this context it only has to be assured that an eavesdropper cannot obtain knowledge with respect to the actual reception on the side of the weak communication partner.

With respect to a data exchange as effective as possible within the network, it can be provided that the strong communication partner exchanges information simultaneously in a star shaped communication pattern with several weak communication partners. It has thereby proven to be particularly efficient, that the plurality of the data pairs is transmitted by the strong communication partner once, thus so that they can be received by each of the weak communication partners. As described above, each of the weak communication partners randomly selects a respective data pair from the plurality of data pairs, so that a respective individual key is established for the communication between the strong communication partner and each of the weak communication partners. Though it is unlikely, it certainly cannot be excluded in this context that several of the weak communication partners accidentally select the same data pair.

In a preferred embodiment, a notebook, a PDA, or a mobile phone is being used as the strong communication partner within the network. However, also other devices are conceivable, wherein it only has to be assured that the device has sufficient power resources, this means computing power, memory capacity, etc., in order to be able to perform the required computations—which during the key exchange occur almost exclusively on its side—with sufficient speed.

In principle, there are no limits with respect to the type of the weak communication partner. For example, the use of sensor nodes and/or RFID transponders proves to be particularly advantageous, this means generally the use of devices with such limited power resources, that conventional key exchange protocols prove to be non executable. Even so-called Mica Motes with only 4 MHz can e.g. be used as processors. In principle, it has to be assured with respect to the configuration of the device for the weak communication partners, that they can receive and decrypt the data pairs transmitted by the strong communication partner and that they can send back a message to the strong communication partner comprising the identification corresponding to the selected data pair.

It should be noted here that the described method can certainly also be used when the “weak” communication partner has the same or at least similar power resources as the “strong” communication partner. However, the particular advantages of the process become the more apparent, the weaker the weak partner actually is.

Thus, there are various possibilities to embody and refine the teachings of the present invention in an advantageous manner. In this context reference is being made on the one hand to the patent claims subsequent to patent claim 1, and on the other hand to the subsequent description of preferred embodiments of the invention with reference to the drawing. In combination with the description of the preferred embodiments of the invention based on the drawing, preferred embodiments and refinements of the teachings are also being described in general. The drawing shows in

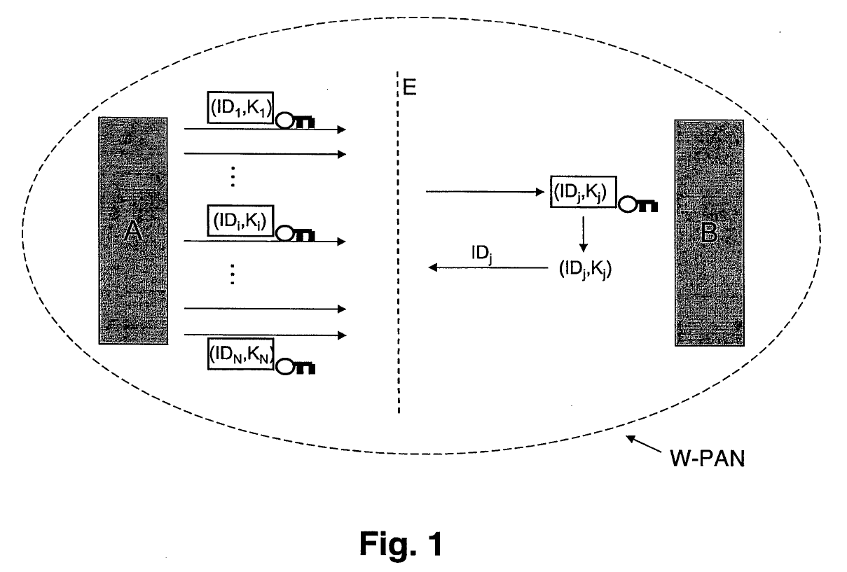

FIG. 1 the function of the method according to the invention in a schematic illustration, and

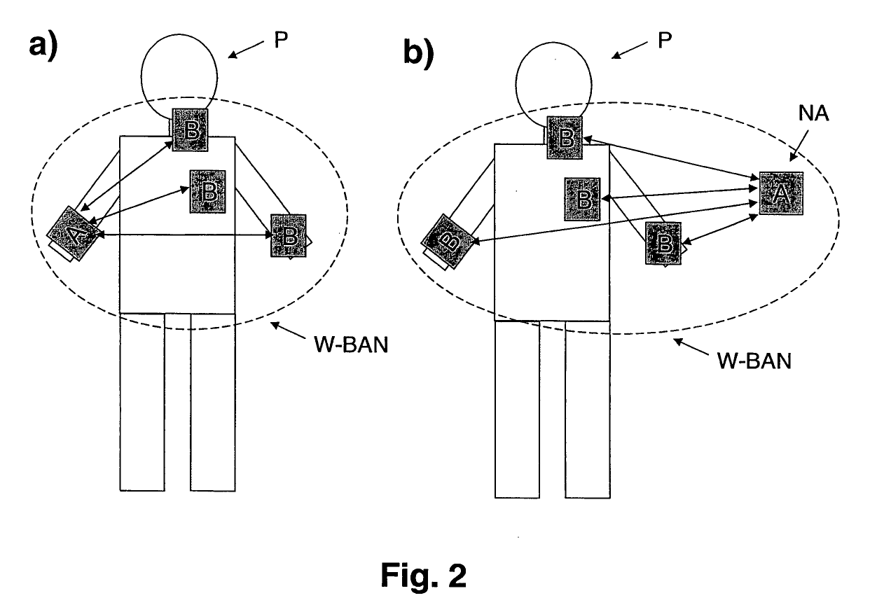

FIG. 2 an application scenario of the method according to the invention in a schematic illustration.

FIG. 1 schematically shows an embodiment of the method according to the invention based on a wireless personal area network (W-PAN). For reasons of clarity only two components of the W-PAN are illustrated, wherein these are a strong communication partner A, and a weak communication partner B. The strong communication partner A is provided in the described embodiment as a notebook with a commercially available CPU and memory capacity. The weak communication partner is provided as RFID transponder, wherein it could also be another device with similarly limited power resources.

For secure data transmission between the communication partners A and B, a secret key is established before the data transmission, through which the data to be transferred are encrypted. For this purpose the communication partner A initially sends a plurality of data pairs to the communication partner B. In the described embodiment a total of N data pairs are being transmitted, wherein each data pair comprises a nonce, designated as an identification ID in this context, as well as a possible secret key K. The data pairs are being transmitted encrypted by A, wherein a weak block encryption is used for encryption. Concretely, this is an AES encryption (Advanced Encryption Standard) with a key length of e.g. 16 bits.

The communication partner B randomly selects one encrypted text from the plurality of encrypted texts. In doing so it is irrelevant if B has actually received all texts 1, . . . , N, transmitted by A or only part of them. Insofar the process according to the invention proves to be very robust against data losses on the wireless channel on the one hand. On the other hand, it enables the weak communication partner B to save energy, since B in the extreme only has to be prepared to receive one single data pair. In the embodiment according to FIG. 1, B has selected the j-th data pair (IDⱼ, Kⱼ) out of the plurality of data pairs transmitted. B breaks the encryption of the data pair, which is possible with very little computation effort, since it is a weak encryption as described above.

In a next step, B sends the nonce IDⱼ back to A. The communication partner A knows the data pairs, which it has encrypted, and accordingly it is able to reconstruct the respective value Kⱼ from the received value IDⱼ. The value Kⱼ then serves as a common secret key for the data transmission between the communications partners A and B.

An eavesdropper E, which eavesdrops upon the transmitted nonce IDⱼ, has no chance to allocate IDⱼ to a data pair or a key, since the nonce ID and the key K have no relationship with each other. The only possibility for E to find out which key has been used is to eavesdrop upon the nonce IDᵢ sent from B to A, and to eavesdrop upon the data pairs transmitted by A, decrypt very many of the data pairs, and accidentally discover the key Kⱼ belonging to the IDⱼ. The security of the method according to the invention is therefore not based on theoretical numerical assumptions, but based on the circumstance that a hostile eavesdropper has to look at a plurality of encrypted texts before he can find the one that was randomly selected by B with a certain probability.

FIG. 2 schematically shows a practical exemplary application of the method according to the invention in a wireless body area network (W-BAN), Practically speaking, this is an application in the area of so-called E-health or telemedicine. In part a) of FIG. 2, a patient P is shown, who is carrying a plurality of biosensors. The biosensors accomplish the most different tasks and e.g. serve for monitoring the heartbeat, the blood pressure, the blood sugar, etc. The biosensors are provided as ultra light devices with respect to their power capacity (RFD-reduced functioning device) and form the weak communication partners B of the W-BANs according to the notation in the embodiment described above. The data measured by the biosensors are being transmitted to a central component of the network, which is the strong communication partner A of the network according to the notation selected in the example described above. In the embodiment according to FIG. 2 a), the strong communication partner A is provided as a control node shaped as a clock, which the patient P carries on his wrist. Via the control node, e.g. an alarm can be given, in case one of the sensors detects measurement values outside a measuring range previously defined as acceptable.

For secure transmission of biometric sensor data to A, the method according to the invention is applied as follows: A sends out a plurality of encrypted data pairs (IDⱼ, Kⱼ), wherein the transmitting power is selected so that the data pairs can be received from the biosensors B in a radius of 1 to 2 meters. Each of the biosensors B randomly selects a data pair, decrypts it and sends the respective ID back to A. A reconstructs the key K belonging to the ID, and the key K then serves as a common key for the data transmission between A and the respective biosensor B.

While the embodiment shown in FIG. 2 a) rather serves for continuous monitoring of patients, e.g. for an in patient sojourn in a hospital, the embodiment shown in FIG. 2 b) can be used in a particularly advantageous manner, e.g. in case of a traffic accident. The important difference between the two embodiments is that the strong communication partner A is not assigned to the patient P himself, but carried by an emergency physician NA. The strong communication partner A in this case is a powerful device (FFD—full functioning device), as e.g. a laptop with 2 GHz processor. As shown in FIG. 2 b), the laptop A of the emergency physician NA, together with the biosensors B of the patient P forms a W-BAN. Before the emergency physician NA reads out the measured data of the biosensors B, a key exchange according to the invention takes place between laptop A and each of the biosensors B, as described in context with FIG. 2 a).

The applications of the method, according to the invention are unlimited in principle. An application in scenarios where security is only required for a limited amount of time is particularly advantageous. An application at large events like concerts or football games appears particularly promising. In such a context sensor nodes can be distributed at the location of the event, e.g. in the concert hall or the stadium, which can look for suspicious materials (e.g. explosives). In a practical application a security team with PDAs as a strong communication partners could monitor the event, where secret keys are previously exchanged with the sensor nodes according to the method according to the invention. This way a sufficient level of security can be realized during the duration of the concert or the game, this means temporarily, so that the integrity of the data transmitted in the relevant time window is assured.

With respect to further advantageous embodiments of the method according to the invention reference is made to the general part of the description and to the appended patent claims, in order to avoid repetitions.

In closing, it shall be explicitly pointed out that the previously described embodiments only serve as a description of the claimed teachings, but do not limit it to the embodiment.

1. A method for establishing a secret key for data transmission between communication partners in a network, in particular in a personal area network (PAN), or in a body area network (BAN), wherein one or several inefficient communication partners (B), in comparison to a strong, preferably central communication partner (A) of the network, have reduced power resources, characterized through the following steps: the strong communication partner (A) transmits a plurality of data pairs, each comprising a possible key (Kₗ) and an identification (IDₗ), to the weak communication partner (B) in a concealed manner, the weak communication partner (B) randomly selects a data pair from the plurality of data pairs, reveals the concealment of the data pair and sends the respective identification (IDⱼ) back to the strong communication partner (A), the strong communication partner (A) reconstructs the associated key (Kⱼ) from the received identification (IDⱼ), said key (Kⱼ) then being used as a secret key for the data transmission between the strong and the weak communication partner.

2. A method according to claim 1, characterized in that, the concealment of the data pairs is accomplished through an encryption by the strong communication partner (A).

3. A method according to claim 2, characterized in that, the strong communication partner (A) sends the data pairs to the weak communication partner (B) with an encryption that can be decrypted easily.

4. A method according to claim 2, characterized in that, the encryption of the data pairs is replaced by a stronger encryption, when it proves to be too weak.

5. A method according to claim 2, characterized in that, the length of the keys (k,), through which the strong communication partner (A) encrypts the data pairs, is determined according to the respective security requirements and/or the respective power capacity of the weak communication partner (B).

6. A method according to claim 2, characterized in that, a RC5 encryption is being used for encrypting the data pairs.

7. A method according to claim 2, characterized in that, the data pairs are expanded by the weak communication partner (B) by a respective characteristic bit string with regard to a correct decryption.

8. A method according to claim 2, characterized in that, the plain text of the data pairs is linked, with respect to a correct decryption of the data pairs by the weak communication partner (B), with the respective key (k,) used for encrypting the data pair.

9. A method according to claim 8, characterized in that, the linking is performed in such a way that the key (k,) used for encrypting the data pairs is generated from a predeterminable number of bits of the key (K₁).

10. A method according to claim 1, characterized in that, the number of the data pairs to be transmitted by the strong communication partner (A) is set according to the respective safety requirements.

11. A method according to claim 1, characterized in that, the strong communication partner (A) sends a message, before sending the first data pair, through which the beginning of the transmission process of the data pairs is indicated to the weak communication partner (B).

12. A method according to claim 11, characterized in that, the message comprises information with respect to the expected duration of the transmission process.

13. A method according to claim 12, characterized in that, the weak communication partner (B) uses the information, so that it switches itself into a ready to receive mode only for a short time during the duration of the transmission process.

14. A method according to claim 1, characterized in that, the strong communication partner (A) simultaneously exchanges data with several weak communication partners (B) according to a star shaped communication procedure.

15. A method according to claim 14, characterized in that, the plurality of the data pairs transmitted by the strong communication partner (A) is received by each of the weak communication partners (B), wherein each of the weak communication partners (B) selects one respective data pair.

16. A method according to claim 1, characterized in that, a notebook, a PDA, or a mobile phone are used as strong communication partner (A) within the network.

17. A method according to claim 1, characterized in that, sensor nodes and/or RFID transponders (radio frequency identification) are being used as weak communication partners (B).

18. A method according to claim 3, characterized in that, the encryption of the data pairs is replaced by a stronger encryption, when it proves to be too weak.

19. A method according to claim 3, characterized in that, the length of the keys (k,), through which the strong communication partner (A) encrypts the data pairs, is determined according to the respective security requirements and/or the respective power capacity of the weak communication partner (B).

20. A method according to claim 4, characterized in that, the length of the keys (k,), through which the strong communication partner (A) encrypts the data pairs, is determined according to the respective security requirements and/or the respective power capacity of the weak communication partner (B).
